(19) United States
(12) Patent Application Publication
(10) Pub. No.: US 2006/0292996 A1
(43) Pub. Date: Dec. 28, 2006

(54) Integrated wireless transceiver

(76) Inventors: Rammohan Malasani, Ongole (IN); Robert J. Pera, San Carlos, CA (US)

Correspondence Address: SWERNOFSKY LAW GROUP PC, P.O. BOX 390013, MOUNTAIN VIEW, CA, 94039-0013, US

(21) Appl. No.: 11/158,728

(22) Filed: Jun. 22, 2005

(51) Int. Cl. H04B 1/44; H04B 1/28

(52) U.S. Cl. 455/78; 455/333

(57) ABSTRACT

An integrated wireless transceiver is described. The integrated wireless transceiver may include a radio, a frequency converter coupled to the radio, a switch coupled to the frequency converter, and at least one antenna coupled to the frequency converter. The radio may be configured to convert a first signal from a baseband to a first band of frequencies and to convert the first signal into a first transmit signal in accordance with a wireless local area network (LAN) communications protocol. The frequency converter may be configured to convert the first transmit signal from the first band of frequencies to a second band of frequencies. The second band of frequencies may correspond to a band of frequencies that is different than one or more bands of frequencies associated with the wireless LAN communications protocol.

### BACKGROUND

1. Field of the Invention

The present invention relates to integrated wireless transceivers. More specifically, the present invention relates to an integrated wireless transceiver for use in wireless local area networks.

2. Related Art

Wireless communications networks, such as those based on an IEEE 802.11 protocol (also known as Wi-Fi), offer flexibility, scalability and reduced expense. As a consequence, such networks are increasingly popular. Wireless communication, however, is subject to a variety of sources of interference, such as multi-path signals, that may degrade performance (resulting for example, in an increased bit error rate for a respective signal-to-noise ratio). In addition, wireless signals between antennas in a respective wireless communication network, may have a limited range. And wireless local area networks that use time division duplexing (such as IEEE 802.11 protocols) may experience performance degradation as wireless users in a given environment aggregate and, in turn, contribute to an increased noise floor and/or cause frequent communications collisions with one another. Unfortunately, it is not always possible to address these and other challenges by simply increasing a transmitted signal power due to regulatory and standards constraints, including communications emissions standards such as restricted band radiated spurious emission (for example, Federal Communications Commission part 15.209a), protocol specific spectral mask requirements (such as those for the IEEE 802.11 protocols), and IEEE form factors and electrical specifications (such as those for mini-PCI, Cardbus, USB, and PCI-express).

Existing wireless transceivers attempt to address these challenges using a variety of techniques, include a plurality of transmit and receive signals (known as multiple input multiple output or MIMO), smart antennas that implement beam forming, and digital signal processing (for example, averaging multiple data streams that are repeatedly transmitted and received). These techniques, however, often entail additional complexity, power consumption and expense in existing wireless transceivers.

There is a need, therefore, for improved wireless transceivers to reduce or eliminate at least some of the problems listed above, and thereby, improve the performance of wireless communication networks.

### SUMMARY

An integrated wireless transceiver is described. The integrated wireless transceiver may include a radio, a frequency converter coupled to the radio, a switch coupled to the frequency converter, and at least one antenna coupled to the switch. The radio may be configured to convert a first signal from a baseband to a first band of frequencies and to convert the first signal into a first transmit signal in accordance with a wireless local area network (LAN) communications protocol. The frequency converter may be configured to convert the first transmit signal from the first band of frequencies to a second band of frequencies. The second band of frequencies may be different than one or more bands of frequencies associated with the wireless LAN communications protocol.

The radio may be configured to convert a first receive signal into a second signal in accordance with the wireless LAN communications protocol and to convert the second signal from the first band of frequencies to the baseband. The frequency converter may be configured to convert the first receive signal from the second band of frequencies to the first band of frequencies.

In a first configuration, the switch may couple the first transmit signal from the frequency converter to the antenna. In a second configuration, the switch may couple the first receive signal from the antenna to the frequency converter. The radio may be configured to provide instructions to select a respective configuration of the switch.

In some embodiments, the integrated wireless transceiver may include a power source. The power source may be configured to provide power to the frequency converter and the radio. The power source may be coupled to a connector. The connector may be configured for coupling to an Ethernet cable.

The integrated wireless transceiver may be compatible with one or more communications emissions standards. The integrated wireless transceiver may be integrated on a printed circuit board. The radio and the frequency converter may use at least one common frequency reference.

In some embodiments, frequencies in the second band of frequencies are less than frequencies in the first band of frequencies. The wireless LAN communications protocol may include compatibility with at least one Wi-Fi protocol and/or a Wi-MAX protocol. In some embodiments, the second band of frequencies may correspond to licensed band of frequencies or an unlicensed band of frequencies.

In some embodiments, the radio may be configured to convert a third signal from the baseband to a third band of frequencies and to convert the third signal into a second transmit signal in accordance with the wireless LAN communications protocol. The frequency converter may be configured to convert the second transmit signal from the third band of frequencies to a second band of frequencies. In the first configuration, the switch may couple the second transmit signal from the frequency converter to the antenna.

In some embodiments, the radio may be configured to convert a second receive signal into a fourth signal in accordance with the wireless LAN communications protocol and to convert the fourth signal from the third band of frequencies to the baseband. The frequency converter may be configured to convert the second receive signal from the second band of frequencies to the third band of frequencies. In the second configuration, the switch couples the second receive signal from the antenna to the frequency converter.

In some embodiments, frequencies in the third band of frequencies may be greater than frequencies in the first band of frequencies and frequencies in the first band of frequencies may be greater than frequencies in the second band of frequencies.

In an alternate embodiment, the integrated wireless transceiver may have two modes of operation. In a first mode of operation, the wireless transceiver may transmit and receive signals using one or more bands of frequencies that are different than one or more bands of frequencies associated with the wireless LAN communications protocol. In a second mode of operation, the wireless transceiver may transmit and receive signals using the one or more bands of frequencies associated with the wireless LAN communications protocol.

In an alternate embodiment, a method is described. In the method, a signal may be converted from baseband to the first band of frequencies. The signal may be converted to the transmit signal in accordance with the wireless LAN communications protocol. The transmit signal may be frequency converted from the first band of frequencies to the second band of frequencies. Frequencies in the second band of frequencies may be less than frequencies in the first band of frequencies. The second band of frequencies may correspond to a band of frequencies that is different than one or more bands of frequencies associated with the wireless LAN communications protocol. The transmit signal may be coupled to the antenna. The converting from baseband, the converting to the transmit signal, the frequency converting and the coupling may be performed in the integrated wireless transceiver.

In another alternate embodiment, a receive signal is coupled from the antenna to the frequency converter. The receive signal may be frequency converted from the second band of frequencies to the first band of frequencies. Frequencies in the second band of frequencies may be less than frequencies in the first band of frequencies. The second band of frequencies may be different than one or more bands of frequencies associated with the wireless LAN communications protocol. The receive signal may be converted to the signal in accordance with the wireless LAN communications protocol. The signal may be converted from the first band of frequencies to baseband. The coupling, the frequency converting, the converting to the signal and the converting to baseband may be performed in the integrated transceiver.

The integrated wireless transceiver may reduce or eliminate the previously described challenges.

### BRIEF DESCRIPTION OF THE FIGURES

Additional objects and features of the invention will be more readily apparent from the following detailed description and appended claims when taken in conjunction with the drawings.

FIG. 1 is a block diagram illustrating an embodiment of bands of frequencies.

FIG. 2 is a block diagram illustrating an embodiment of an integrated wireless transceiver.

FIG. 3 is a block diagram illustrating an embodiment of an integrated wireless transceiver.

FIG. 4 is a block diagram illustrating an embodiment of a frequency band data structure.

FIG. 5 is a flow diagram illustrating an embodiment of a method for converting a signal.

FIG. 6 is a flow diagram illustrating an embodiment of a method for converting a signal.

FIG. 7A is a block diagram illustrating an embodiment of an integrated wireless transceiver.

FIG. 7B is a block diagram illustrating an embodiment of an integrated wireless transceiver.

FIG. 8 is a block diagram illustrating an embodiment of filtering.

FIG. 9 is a block diagram illustrating an embodiment of a power splitter/combiner.

Like reference numerals refer to corresponding parts throughout the drawings.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

Embodiments of an apparatus and related methods for an integrated wireless transceiver are described. The integrated wireless transceiver may allow transmitting of transmit signals and receiving of receive signals that are compatible with one or more wireless local area network (LAN) communications protocols using one or more bands of frequencies that are different than one or more band of frequencies that are associated with the one or more wireless LAN communications protocols. The integrated wireless transceiver may transmit and receive utilizing one or more unlicensed bands of frequencies. Unlicensed bands of frequencies may be subject to governmental communications emissions regulations, such as those issued and enforced by the Federal Communications Commission (FCC) in the United States, but may not be restricted to a particular user or class of users and/or a type of communications application.

In an exemplary embodiment, the one or more bands of frequencies used by the integrated wireless transceiver for transmitting and receiving may have frequencies that are lower than the frequencies in the one or more bands of frequencies that are associated with the one or more wireless LAN communications protocols. The use of lower frequencies for transmitting and receiving may extend a communications range and/or improve a performance of the integrated wireless transceiver relative to existing wireless transceivers that transmit and receive utilizing the one or more bands of frequencies associated with the one or more wireless LAN communications protocols. Applications of the integrated wireless transceiver may include a variety of wireless networks, including enterprise, LAN, metropolitan area networks (MAN) and/or outdoor bridging.

In some embodiments, the integrated wireless transceiver may operate in one or two modes. In a first mode, the integrated wireless transceiver may transmit and receive signals using the one or more bands of frequencies that are different than one or more bands of frequencies associated with one or more wireless LAN communications protocols. In a second mode, the integrated wireless transceiver may transmit and receive signals using the one or more bands of frequencies associated with the one or more wireless LAN communications protocols.

The one or more wireless LAN communications protocols may include at least one Wi-Fi protocol and/or at least one Wi-MAX protocol. As a consequence, the one or more wireless LAN communications protocols in this discussion should be understood to include those used for one or more LANs and/or one or more MANs. In some embodiments, the one or more wireless LAN communications protocols may be compatible with at least one Wi-Fi protocol and/or at least one Wi-MAX protocol. For example, while portions of a respective wireless LAN communications protocol may be compatible with a physical layer and/or medium access control (MAC) layer for a respective Wi-Fi protocol, other higher-level aspects of the respective Wi-Fi protocol (such as one or more carrier frequencies, spectral mask requirements, and/or transmission bandwidths) may be modified and/or adjusted.

The one or more wireless LAN communications protocols may include IEEE 802.11a, IEEE 802.11b, IEEE 802.11g, IEEE 802.11n, Wi-MAX and/or Bluetooth. The one or more bands of frequencies associated with the one or more wireless LAN communications protocols may approximately include 2390-2480 MHZ and/or 4900-6000 MHz. In some embodiments, the one or more bands of frequencies associated with the one or more wireless LAN communications protocols may approximately include 2400, 2500, 3600, 5800 and/or 7000 MHz. The one or more transmit and receive bands of frequencies that are different from the one or more bands of frequencies associated with one or more wireless LAN communications protocols may approximately include 902-928 MHz and/or 3650-3700 MHz.

The integrated wireless transceiver may be implemented on a compact printed circuit board, such as a mini-PCI card or a PCMCIA card. The printed circuit board may include one or more cable connectors, such as one or more SMA connectors, one or more MMCX connectors, and/or one or more UFL connectors. The one or more SMA connectors may offer reduced signal loss relative to the one or more UFL connectors in conjunction with one or more cables (sometimes referred to as pigtails). Since some of the applications of the integrated wireless transceiver are outdoors, a larger transmit power than allowed in a low power/low cost environment, such as a laptop computer, may be utilized. In an exemplary embodiment, high transmit power while still working within the 3.3 V limit and form factor requirements of the IEEE mini-PCI and Cardbus standards may be achieved by using a discrete power combiner. In this way, the transmit power for an embodiment of the integrated wireless transceiver implemented on a mini-PCI or Cardbus may exceed 2 W.

The integrated wireless transceiver may address band edge challenges associated with the one or more bands of frequencies associated with the one or more wireless LAN communications protocols. In particular, communications emissions standards or regulations associated with one or more band edges may be challenging (such as the 2390 MHz and 2483.5 MHz restricted edges defined in FCC part 15.247c). One or more filters having one or more center frequencies inside of one of more of the bands of frequencies may be used. A respective filer may have a bandwidth (based, for example, on a 3 dB or 6 dB criterion) that is less than a bandwidth of a corresponding band of frequencies associated with the one or more wireless LAN communications protocols. The one or more filters may achieve the communications emissions regulations thereby ensuring regulatory compliance for the integrated wireless transceiver. The one or more filters may accomplish this without appreciable additional group delay. As a consequence, a transmit power for one or more bands of frequencies associated with the one or more wireless LAN communications protocols may be increased relative to embodiments without the one or more filters. In some embodiments, the transmit power may be common for two or more bands of frequencies associated with the one or more wireless LAN communications protocols.

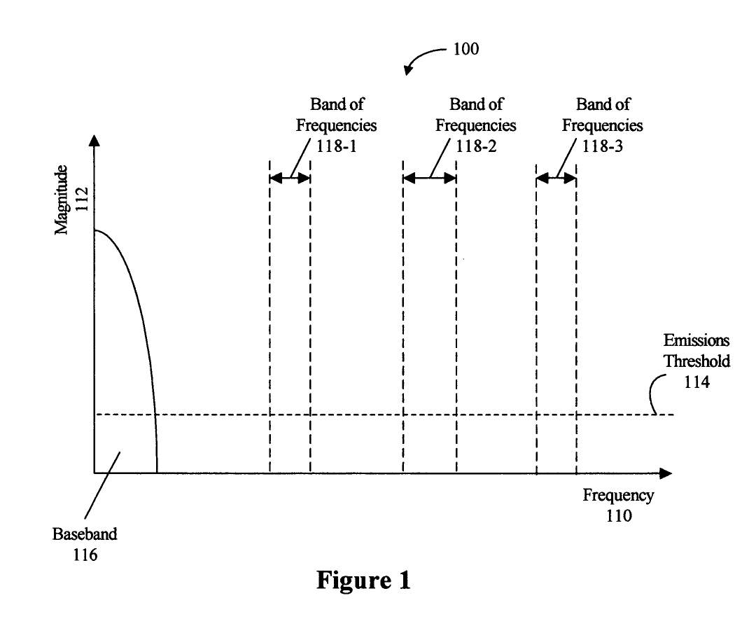

Attention is now directed towards embodiments of the wireless LAN transceiver. FIG. 1 is a block diagram illustrating an embodiment 100 of bands of frequencies. A magnitude 112 versus frequency 110 is shown for a baseband 116, and several bands of frequencies 118. An emission thresholds 114 corresponding to a communications emission standard or regulation for a maximum emissions magnitude between the bands of frequencies 118 is also shown. In an exemplary embodiment, one or more of the bands of frequencies 118-2 and 118-3 may be associated with one or more wireless LAN communications protocols, such as Wi-Fi. The integrated wireless transceiver may convert one or more first signals (including first data) from baseband 116 to one or more of the bands of frequencies 118-2 and 118-3. The one or more first signals may be converted to transmit signals (including first data packets corresponding to the first data) in accordance with at least one of the one or more wireless LAN communications protocols.

For example, data packets in an IEEE 802.11 protocol generally include a preamble/header and a payload (with the corresponding data). The preamble/header may include information that indicates that a data packet follows. The preamble/header may also include information about a respective data packet, such as its size, data rate, and timing information. Binary data for inclusion in the payload may be mapped into symbols in accordance with one of several signal-to-noise ratio-determined modulations (for example, binary phase shift keying, quadrature phase shift keying, 16-level quadrature amplitude modulation, and/or 64-level quadrature amplitude modulation). The resulting symbols (corresponding to the binary data) may be converted from baseband directly (i.e., without an intermediate frequency) to one or more carrier frequencies, for example, in one or more of the bands of frequencies 118-2 and 118-3. Some of the IEEE 802.11 protocols may utilize orthogonal frequency division multiplexing (ODFM).

The transmit signals may be converted to band of frequencies 118-1 for transmission. In an exemplary embodiment, the band of frequencies 118-1 may be an unlicensed band of frequencies and/or a band of frequencies (licensed or unlicensed) that is different than one or more bands of frequencies associated with one or more wireless LAN communications protocols. Note that frequencies in the band of frequencies 118-1 may be less than frequencies in the bands of frequencies 118-2 and 118-3.

Received receive signals (including second data packets) may be converted by the integrated wireless transceiver from the band of frequencies 118-1 to one or more of the bands of frequencies 118-2 and 118-3. The receive signals may be converted to one or more second signals (including second data corresponding to the second data packets) in accordance with at least one of the one or more wireless LAN communications protocols. The one or more second signals may be converted from one or more of the bands of frequencies 118-2 and 118-3 to baseband 116. In other words, at an antenna the receive signals may have an RF carrier frequency that is less than a frequency in one of the frequency bands 118-2 and 118-3. After up-converting to one of these bands of frequencies, the resulting signals may be down-converted to baseband by a WLAN radio. The process may be reversed for the transmitter chain described above.

In an exemplary embodiment, the band of frequencies 118-1 may approximately include 902-928 MHz, the band of frequencies 118-2 may approximately include 2390-2480 MHz, and the band of frequencies 118-3 may approximately include 4900-6000 MHz. In other embodiments, the band of frequencies 118-2 may approximately include 2402-2480 MHz, and the band of frequencies 118-3 may approximately include 5000-5900 MHz. In other embodiments, the band of frequencies 118-2 and/or the band of frequencies 118-3 may approximately include frequency bands in the 500 MHz and/or 700 MHz, as well as between 3650-3700 MHz.

While baseband 116 is illustrated including DC, in some embodiments baseband may not include DC. In addition, while three bands of frequencies 118 are illustrated in embodiment 100, in other embodiments there may be fewer or additional bands of frequencies 118, including fewer or additional bands of frequencies associated with the one or more wireless LAN communications protocols, additional unlicensed bands of frequencies and/or additional bands of frequencies that are different than the band of frequencies associated with the one or more wireless LAN communications protocols.

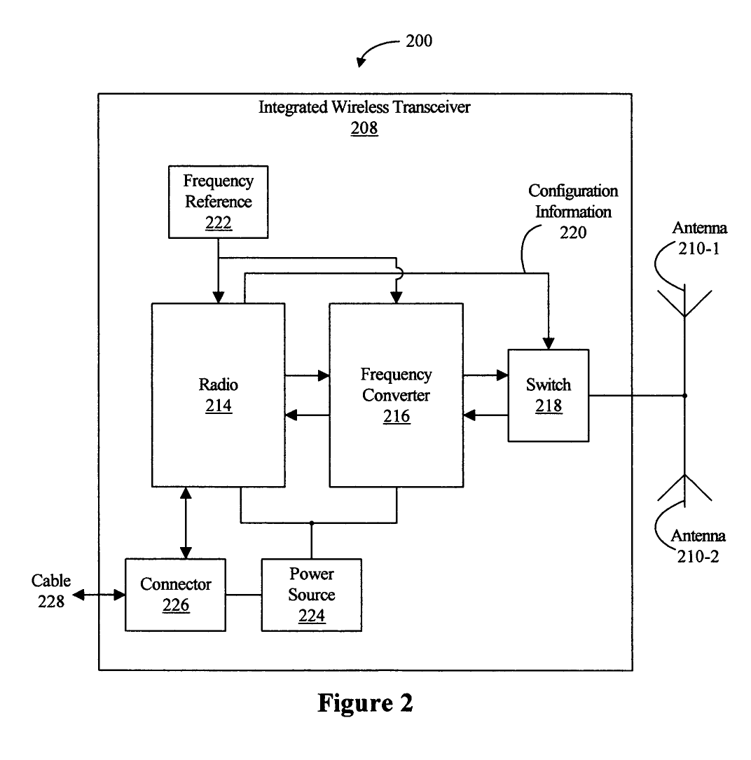

FIG. 2 is a block diagram illustrating an embodiment 200 of an integrated wireless transceiver 208. The integrated transceiver 208 includes a radio 214 that converts the one or more first signals from baseband, converts the one or more first signals to transmit signals, converts receive signals to the one or more second signals and converts the one of more second signals to baseband. In exemplary embodiment, the radio 214 may be an RF integrated circuit (including a physical layer and a MAC layer) from Atheros Communications, such as model AR5004 or AR5006 (the AR5213/AR2112 is also referred to as the AR5004 design). Transmit and receive signal paths from the radio 214 are coupled to a frequency converter 216. The frequency converter 216 may be coupled to a radio frequency (RF) interface, a baseband interface and/or a power net interface in the radio 214. The frequency converter 216 may convert transmit signals from one or more of the bands of frequencies 118-2 (FIG. 1) and 118-3 (FIG. 1) to the band of frequencies 118-1 (FIG. 1), and receive signals from the band of frequencies 118-1 (FIG. 1) to one or more of the bands of frequencies 118-2 (FIG. 1) and 118-3 (FIG. 1). The transmit and receive signal paths are coupled to a transmit/receive switch 218 and to one or more antennas 210. In some embodiments, the switch 218 may be a duplexer.

The radio 214 and the frequency converter 216 may be coupled to at least one common frequency reference 222. The frequency reference 222 may provide one or more frequency signals that are used in converting between at least two of the bands of frequencies 118 (FIG. 1). The frequency reference 222 may include one or more local oscillators, one or more phase locked loops, and/or one or more delay locked loops.

The radio 214 may provide configuration instructions or configuration information 220 to the switch 218. The configuration information 220 may select coupling the transmit signal path or the receive signal path to the one or more antennas 210. The configuration information 220 may include digital switching instructions. The configuration information 220 may allow the integrated wireless transceiver 208 to operate in a half duplex mode (transmit and receive) without using power monitors to control a configuration of the switch 218. This may allow faster switching times, which in turn, may allow the integrated wireless transceiver 208 to more easily receive equalization information included at the beginning of information packets in the receive signals. Note that the integration of the transceiver may also allow the elimination of costly RF attenuators and/or variable gain amplifiers.

The radio 214 and the frequency reference 216 may be coupled to a power source 224, such as a voltage regulator. The power source 224 may be coupled to a connector 226 and a cable 228, such as an Ethernet cable. The cable 228 may provide power to the integrated wireless transceiver 208. In an exemplary embodiment, signals on the cable 228 may utilize 24 and/or 48 V. The power source 224 may output 3.3 and/or 5 V. The use of a common power source 224 may allow the integrated wireless transceiver 208 to achieve a low noise figure.

The common frequency reference 222, the common power source 224, and/or the configuration information 220 may allow the integrated wireless transceiver 208 to comply with one or more communications emissions standards and/or achieve wireless modular compliance (in accordance, for example, with FCC part 15.247, Europe RT&T Directives, and many other country-specific wireless regulations). In some embodiments, the integrated wireless transceiver 208 may be able to comply with one or more communications emissions standards and utilize a larger transmit power than may be possible by coupling a nonintegrated frequency converter (for example, an external module) to an antenna output port of the radio 214. Such an external module may also utilize a power monitor to allow half duplex operation, with the associated limitations described previously.

The integrated wireless transceiver 208 may be implemented using one or more integrated circuits on a printed circuit board. In some embodiments, the integrated wireless transceiver 208 may be implemented as a single integrated circuit or as a module that is incorporated into an integrated circuit.

In some embodiments, the integrated wireless transceiver 208 may optionally include encryption of the transmit and receive signals, for example, AES 256-bit encryption. The integrated wireless transceiver 208 may also optionally include burst transmission capability and/or frequency hopping.

While the integrated wireless transceiver 208 contains several components, it should be understood that there may be fewer or additional components. A function of some components may, at least in part, be performed by another component. Two or more components may be combined. A position of one or more of the components may be changed.

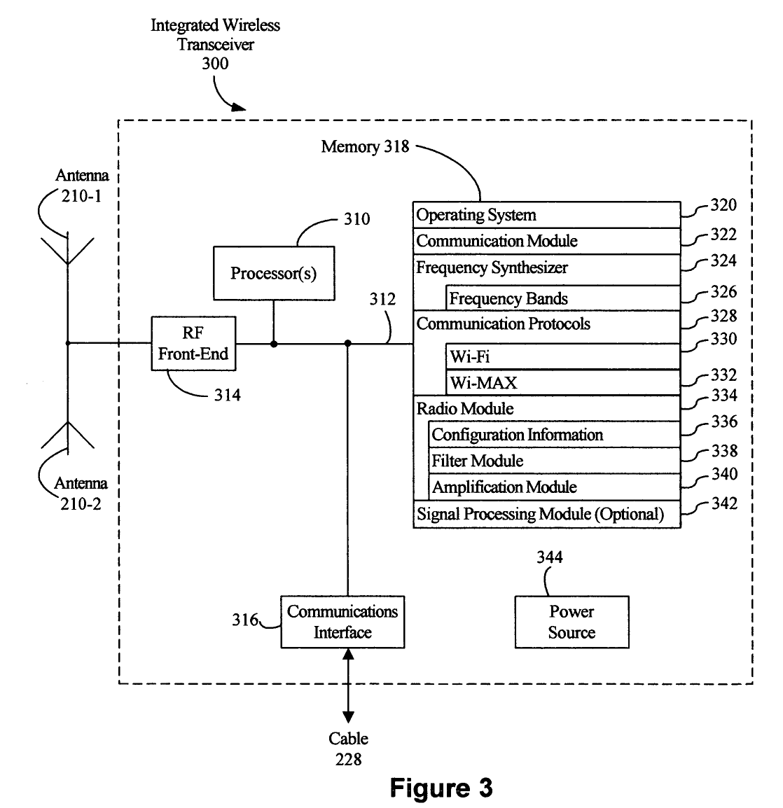

The integrated wireless transceiver 208 may be implemented in hardware and/or in software. This is illustrated in FIG. 3, which is a block diagram of an embodiment of an integrated wireless transceiver 300. One or more antennas 210 are coupled to RF front end 314. Signals from the RF front end 314 are coupled to one or more processors 310, a communications interface 316 and a memory 318. The components in the integrated wireless transceiver 300 may be coupled by one or more signal lines 312. The one or more signal lines may correspond to a signal bus. The communications interface 316 may be coupled to the cable 228. The integrated wireless transceiver 300 may include a power source 344.

The memory 318 may include primary and secondary storage. The memory 318 may include high-speed random access memory and/or non-volatile memory, including ROM, RAM, EPROM, EEPROM and/or FLASH. The memory 318 may store an operating system 320, such as LINUX, UNIX, OS10, WINDOWS, or an embedded operating system such as VxWorks. The operating system 320 may include procedures (or a set of instructions) for handling various basic system services for performing hardware dependent tasks. The memory device 318 may also store procedures (or a set of instructions) in a communications module 322. The communication procedures may be used for communicating with other wireless transceivers and/or using the communications interface 316. The communication procedures may include those for Ethernet.

The memory 318 include a frequency synthesizer 324 (or a set of instructions), communications protocols 328 (or a set of instructions), a radio module 334 (or a set of instructions), and/or an optional signal processing module (or a set of instructions) 342. The frequency synthesizer 324 may include information corresponding to one or more frequency bands 326. The communications protocols 328 may include one or more Wi-Fi protocols 330 and/or one or more Wi-MAX protocols 332. The radio module 334 may include configuration information (or a set of instructions) 336, a filter module (or a set of instructions) 338, and/or an amplification module (or a set of instructions) 340.

The integrated wireless transceiver 300 may include fewer or additional modules and/or components. Two or more modules and/or components may be combined. A position of one or modules and/or one or more components may be moved. At least a portion of the hardware in the integrated wireless transceiver 300 may be implemented in software and at least a portion of the software in the integrated wireless transceiver 300 may be implemented in hardware, such as one or more application specific integrated circuits (ASICs).

At least a portion of the integrated wireless transceiver 300 may be implemented as a library of modules for use, for example, in one or more integrated circuits and/or one or more ASICS.

The devices and circuits described herein may be implemented using computer aided design tools available in the art, and embodied by computer readable files containing software descriptions of such circuits, at behavioral, register transfer, logic component, transistor and layout geometry level descriptions communicated by carrier waves or stored on storage media. Data formats in which such descriptions may be implemented include, but are not limited to, formats supporting behavioral languages such as C, formats supporting geometry description languages such as GDSII, GDSIII, GDSIV, CIF, and MEBES, formats supporting register transfer level RTL languages such as Verilog and VHDL, and other suitable formats and languages. Data transfers of such files on machine readable media including carrier waves may, for example, be performed electronically over diverse media on the Internet or through email. Physical files containing such data may be implemented on computer readable media and/or machine readable media such as 4 mm magnetic tape, 8 mm magnetic tape, floppy disk media, hard disk media, optical media (CDs and/or DVDs), and so on.

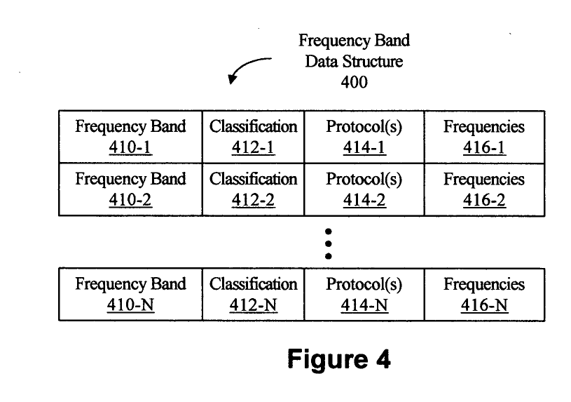

FIG. 4 is a block diagram illustrating an embodiment of a frequency band data structure 400, such as the frequency bands 326 (FIG. 3). The frequency band data structure 400 may include one or more entries for a frequency band 410, a classification 412 (such as licensed or unlicensed), wireless LAN communication protocol(s) 414, and/or frequencies 416 corresponding to one or more bands of frequencies.

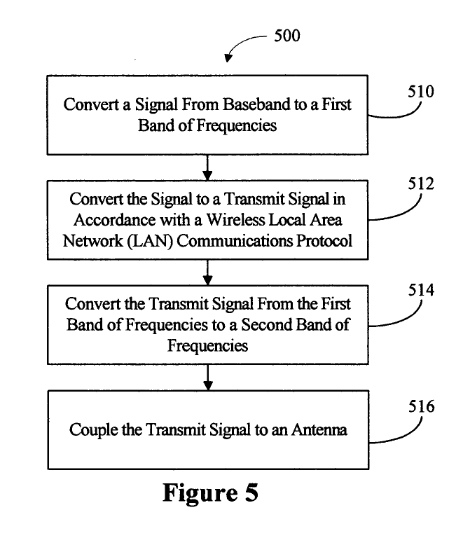

Attention is now directed towards embodiments of processes for using the integrated wireless transceiver. FIG. 5 is a flow diagram illustrating an embodiment of a method 500 for converting a signal. A signal may be converted from baseband to a first band of frequencies (510). The signal may be converted to a transmit signal in accordance with a wireless local area network (LAN) communications protocol (512). The transmit signal may be converted from the first band of frequencies to a second band of frequencies (514) that is an unlicensed band of frequencies and/or a band of frequencies different than those associated with one or more wireless LAN communications protocols. The transmit signal may be coupled to an antenna (516). The method 500 may include fewer or additional operations. Two or more operations may be combined into a single operation. Positions of at least two of the operations may be switched.

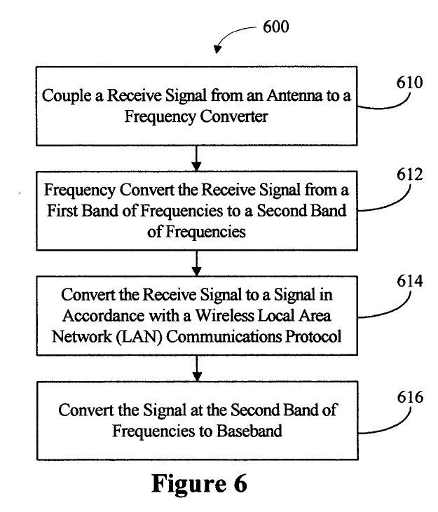

FIG. 6 is a flow diagram illustrating a method 600 for converting a signal. A receive signal may be coupled from an antenna to a frequency converter (610). The receive signal may be frequency converted from a first band of frequencies that is different than those associated with one or more wireless LAN communications protocols to a second band of frequencies (612). The receive signal may be converted to a signal in accordance with a wireless local area network (LAN) communications protocol (614). The signal at the second band of frequencies may be converted to baseband (616). The method 600 may include fewer or additional operations. Two or more operations may be combined into a single operation. Positions of at least two of the operations may be switched.

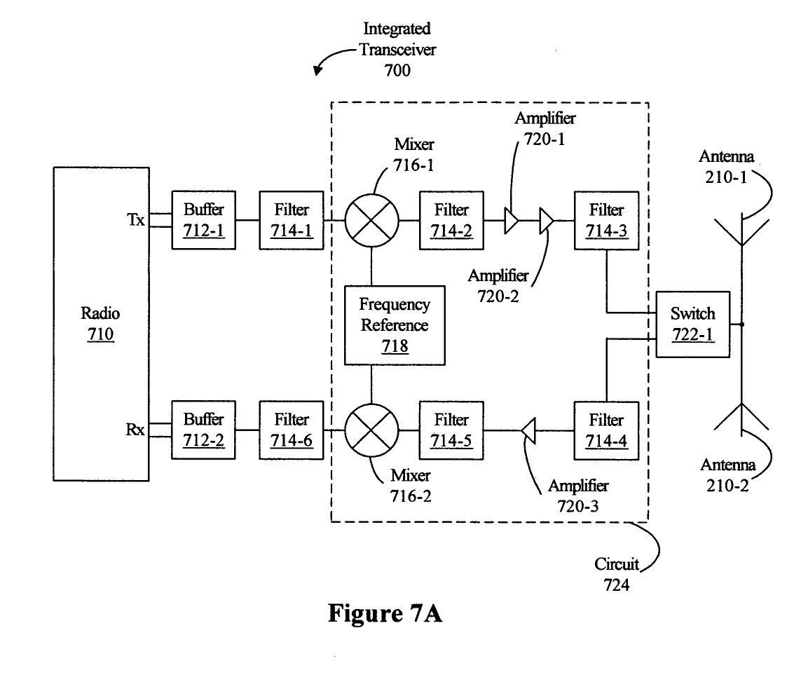

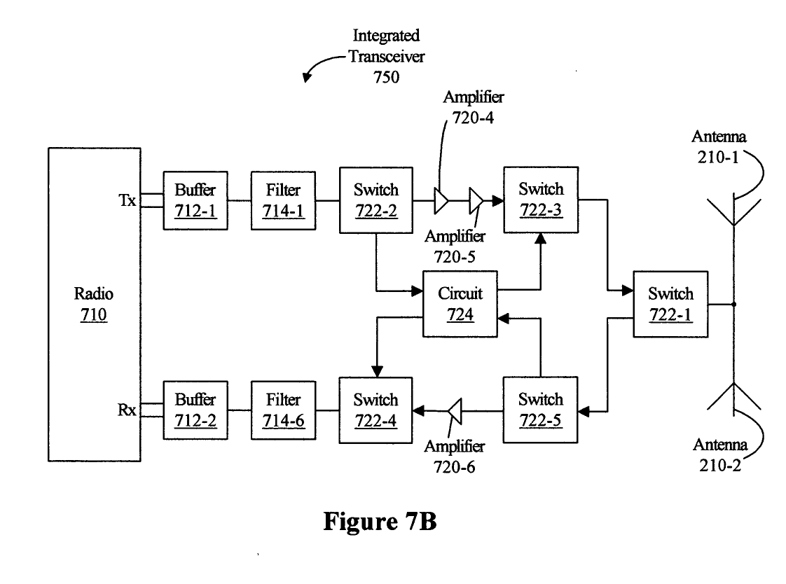

Attention is now directed to additional embodiments of the integrated wireless transceiver. FIG. 7A is a block diagram illustrating an embodiment of an integrated wireless transceiver 700. In a transmit signal path, a radio 710 may be coupled to a buffer 712-1, a filter 714-1, a mixer or modulator 716-1, a filter 714-2, two power amplifiers 720-1 and 720-2, a filter 714-3, a switch 722-1, and one or more antennas 210. In a receive signal path, the one or more antennas 210 may be coupled to the switch 722-1, a filter 714-4, a low noise amplifier 720-3, a filter 714-5, a mixer or modulator 716-2, a filter 714-6, and a buffer 712-2. The mixers 716 may be coupled to a frequency reference 718. The frequency reference 718 may include one or more local oscillators, one or more phase locked loops, and/or one or more delay locked loops. In some embodiments, the switch 722-1 may be a duplexer. With reference to FIG. 7B below, several components may define a circuit 724.

In an exemplary embodiment, the radio 710 uses an IEEE 802.11 protocol and outputs transmit signals in a band of frequencies approximately including 2400 MHz. The buffers 712 may include a differential amplifier and/or a balun. The filters 714 may be surface acoustic wave (SAW) filters. Filters 714-1 and 714-6 may approximately include 2400 MHz in their passbands. The passband bandwidths may be 50 MHz (using, for example, a 6 dB criterion). The frequency reference 718 may output signals having fundament component frequencies of 1500 MHz and/or 3300 MHz. The mixers 716 may down-convert to and up-convert from a band of frequencies approximately including 900 MHz. The filters 714-2 and 714-5 may have passband bandwidths of 30 MHz. The power amplifiers 720-1 and 720-2 may have gains of 20 and 30 dB, respectively. The low noise amplifier 720-3 may have a gain of 17 dB. The filters 714-3 and 714-4 may be optional. The antennas may be designed and/or configured for operation at frequencies approximately including 900 MHz. The integrated wireless transceiver 700 may offer one 20 MHz channel having a data rate of 54 Mbps or up to 4, 5 MHz channels each having a data rate of 11 Mbps.

The integrated wireless transceiver 700 may include fewer or additional components, such as optional impedance matching components. Two or more components may be combined into a single component. A position of one or more of the components may be changed.

FIG. 7B is a block diagram illustrating an embodiment of an integrated wireless transceiver 750 having two modes of operation. In a first mode of operation, switches 722-2 and 722-3 couple transmit signals to circuit 724 for down-conversion, and switches 722-4 and 722-5 couple receive signals to circuit 724 for up-conversion. In a second mode of operation, switches 722-2 and 722-3 couple transmit signals to power amplifiers 720-4 and 720-5 without down-conversion, and switches 722-4 and 722-5 couple receive signals to low noise amplifier 720-6 without up-conversion. As a consequence, the integrated wireless transceiver 750 may transmit and receive signals in one or more unlicensed bands of frequencies, one or more frequencies bands different than those associated with one or more wireless LAN communications protocols, and/or one or more of the bands of frequencies associated with one or more wireless LAN communications protocols. The one or more antennas 210 may be configured, modified and/or adapted for operation at these different frequencies.

The integrated wireless transceiver 750 may include fewer or additional components, such as optional impedance matching components. Two or more components may be combined into a single component. A position of one or more of the components may be changed.

Attention is now directed towards alternate embodiments of the integrated wireless transceiver. These embodiments may be implemented in embodiments with and/or without up and down conversion to one or more unlicensed bands of frequencies and/or bands of frequencies that are different than those associated with one or more wireless LAN communications protocols.

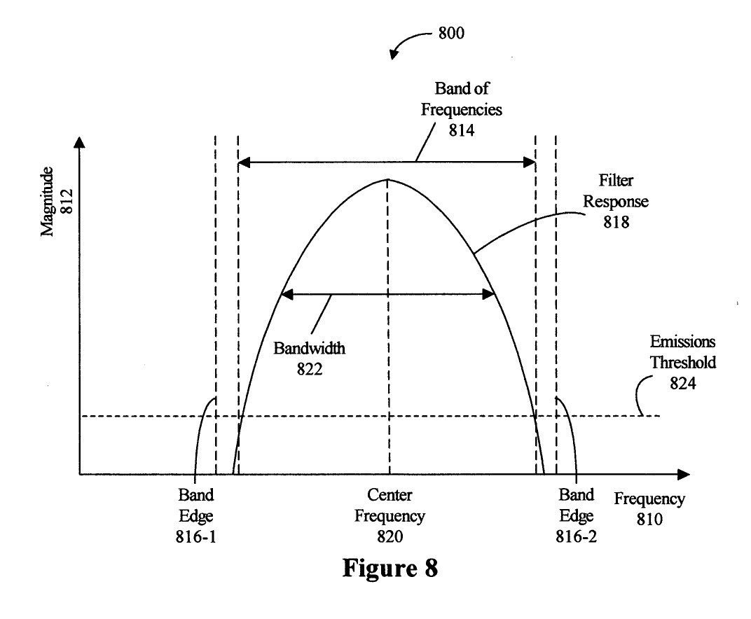

FIG. 8 is a block diagram illustrating an embodiment of filtering 800. A magnitude 812 is shown as a function of frequency 810. A band of frequencies 814 is defined by band edges 816. The band edges 816 may be subject to communications emission standards or regulations, as illustrated by emissions threshold 824. In existing transceivers, it may be challenging to achieve compliance with the emissions threshold 824. A filter having a filter response 818 may be used to address this challenge. The filter may have a center frequency 820 located in the band of frequencies 814. The filter may have a bandwidth 822 (corresponding to a 3 dB or 6 dB passband) that is less than the band of frequencies 814. The filter may achieve regulatory compliance with the emission threshold 824 without introducing appreciable group delay. This may allow a transmit power for transmit signals in the band of frequencies 814 to be increased.

In an exemplary embodiment, band edge 816-1 may be 2390 MHz and band edge 816-2 may be 2483.5 MHz. The band of frequencies 814 may be between 2403-2471 MHz, i.e., some 68 MHz wide (including Wi-Fi channel 1 with a center frequency at 2412 MHz and Wi-Fi channel 11 at 2462 MHz), and the bandwidth 822 may be 50 MHz. The filter response 818 may be implemented using one or more SAW filters. For example, a first SAW filter may have a center frequency at 2408 MHz and a second SAW filter may have a center frequency at 2465 MHz.

In the exemplary embodiment, the filter response 818 may effectively remove sidelobes from transmit and receive signals having carrier frequencies within the band of frequencies 814 that extend past one or more of the band edges 816. The resulting high attenuation at the band edges 816 may reduce emissions at the (restricted) band edges 816 thereby helping to ensure compliance with one or more communications emissions standards.

For example, direct sequencing spread spectrum signals in the IEEE 802.11b protocol may be about 18 MHz wide and the ODFM signals in the IEEE 802.11g protocol may be about 16 MHz wide. The spectral content of the signals may have sidelobes (for the IEEE 802.11b protocol) and/or diagonal slopes/shoulders (for the IEEE 802.11g protocol) that result in emissions above the FCC restricted limits in the restricted bands below 2390 MHz and above 2483.5 MHz. These spurious emissions often restrict the transmit power for channels 1 and 11 in existing reference designs. In addition, since the FCC restricted limits are defined as radiated limits, the use of antennas with higher gains may only compound the problem.

The filter having filter response 818 may address this challenge by effectively chopping off part of the 16-18 MHz wide signals corresponding to channels 1 and/or channel 11 allowing compliance with one or more communications emissions standards and the use of a compliant high transmit power for channels 1 and/or 11, even when high-gain antennas are used. The transmit power may be larger than that for existing reference designs. The filter may accomplish this without an appreciate increase in the group delay or an increase in bit errors.

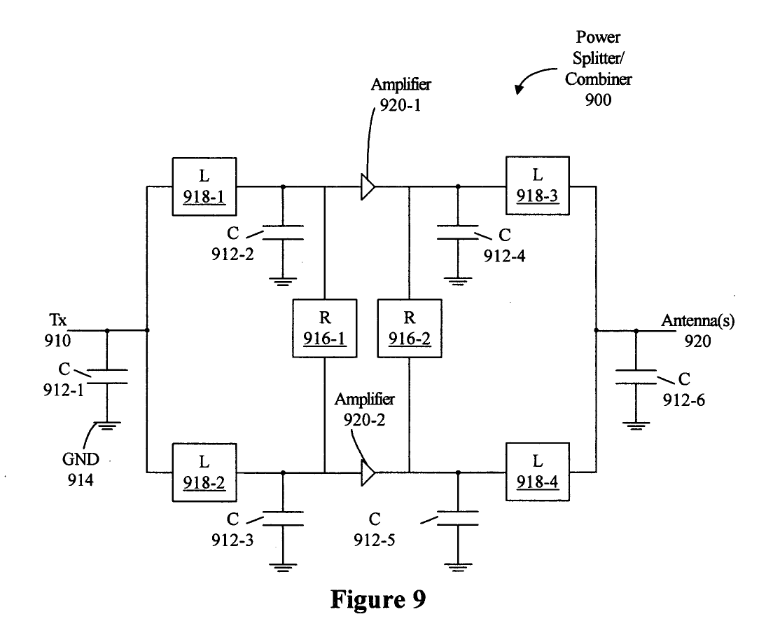

FIG. 9 is a block diagram illustrating an embodiment of a power splitter/combiner 900. The power splitter/combiner 900 may allow boosting of a transmit power even with a limited supply voltage, such as 3.3 V and a form factor constraint for a PCMCIA card. This may be achieved by using two power amplifiers in parallel with a double power output. In an exemplary embodiment, the transmit power may be greater than 2 W. The power splitter/combiner 900 may utilize discrete components thereby allowing a compact (size) implementation relative to existing approaches that may have a size scale of at least half of the wavelength (some 6+ cm at 2400 MHz). In the power splitter/combiner 900, a transmit signal 910 is coupled to a capacitor C 912-1 to ground 914 in parallel with two paths. A first path has an inductor L 918-1 coupled to a capacitor C 912-2, a resistor 916-1, a power amplifier 920-1, a resistor 916-2, a capacitor C 912-4 and an inductor 918-3. A second path has an inductor L 918-2 coupled to a capacitor C 912-3, the resistor 916-1, a power amplifier 920-2, the resistor 916-2, a capacitor C 912-5 and an inductor 918-4. Outputs from the first and second paths are coupled to capacitor C 912-6 and one or more antennas 920.

In an exemplary embodiment, the components in the first and second paths on either side (to the left and to the right) of the power amplifiers 920 approximately implement 50 Ω impedance matching at 2400 MHz. The resistors R 916 may be 100 Ω, the inductors L 918 may be 3.3 nH, capacitors C 912-1 and 912-6 may be 1.8 pF, and the capacitors C 912-2, 912-3, 912-4 and 912-5 may be 0.9 pF.

The power splitter/combiner 900 may include fewer or additional components. Two or more components may be combined. A position of one of more components may be changed.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. An integrated wireless transceiver, comprising:
a radio, wherein the radio is configured to convert a first signal from a baseband to a first band of frequencies and to convert the first signal into a first transmit signal in accordance with a wireless local area network (LAN) communications protocol, and wherein the radio is configured to convert a first receive signal into a second signal in accordance with the wireless LAN communications protocol and to convert the second signal from the first band of frequencies to the baseband;
a frequency converter coupled to the radio, wherein the frequency converter is configured to convert the first transmit signal from the first band of frequencies to a second band of frequencies, the second band of frequencies is different than one or more bands of frequencies associated with the wireless LAN communications protocol, and wherein the frequency converter is configured to convert the first receive signal from the second band of frequencies to the first band of frequencies;
a switch coupled to the frequency converter; and
at least one antenna coupled to the switch,
wherein in a first configuration the switch couples the first transmit signal from the frequency converter to the antenna, and in a second switching configuration the switch couples the first receive signal from the antenna to the frequency converter, and wherein the radio is configured to provide instructions to select a respective configuration of the switch.

2. The integrated wireless transceiver of claim 1, further comprising a power source, wherein the power source is configured to provide power to the frequency converter and the radio.

3. The integrated wireless transceiver of claim 2, wherein the power source is coupled to a connector, and wherein the connector is configured for coupling to an Ethernet cable.

4. The integrated wireless transceiver of claim 1, wherein the integrated wireless transceiver is compatible with one or more communications emissions standards.

5. The integrated wireless transceiver of claim 1, wherein the integrated wireless transceiver is integrated on a printed circuit board.

6. The integrated wireless transceiver of claim 1, wherein the first band of frequencies is approximately between 2390 and 2480 MHz.

7. The integrated wireless transceiver of claim 1, wherein the second band of frequencies is approximately between 902 and 928 MHz.

8. The integrated wireless transceiver of claim 1, wherein the second band of frequencies is approximately between 3650 and 3700.

9. The integrated wireless transceiver of claim 1, wherein frequencies in the second band of frequencies are less than frequencies in the first band of frequencies.

10. The integrated wireless transceiver of claim 1, wherein the wireless LAN communications protocol includes compatibility with at least one Wi-Fi protocol.

11. The integrated wireless transceiver of claim 1, wherein the wireless LAN communications protocol includes compatibility with a protocol selected from the group of protocols consisting of IEEE 802.11a, IEEE 802.11b, IEEE 802.11g and IEEE 802.11n.

12. The integrated wireless transceiver of claim 1, wherein the wireless LAN communications protocol includes compatibility with a Wi-MAX protocol.

13. The integrated wireless transceiver of claim 1, wherein the radio is further configured to convert a third signal from the baseband to a third band of frequencies and to convert the third signal into a second transmit signal in accordance with the wireless LAN communications protocol, and wherein the radio is configured to convert a second receive signal into a fourth signal in accordance with the wireless LAN communications protocol and to convert the fourth signal from the third band of frequencies to the baseband;
the frequency converter is further configured to convert the second transmit signal from the third band of frequencies to a second band of frequencies, and wherein the frequency converter is further configured to convert the second receive signal from the second band of frequencies to the third band of frequencies;
and wherein in the first configuration the switch couples the second transmit signal from the frequency converter to the antenna, and in the second switching configuration the switch couples the second receive signal from the antenna to the frequency converter.

14. The integrated wireless transceiver of claim 13, wherein the third band of frequencies is approximately between 4900 and 6000 MHz.

15. The integrated wireless transceiver of claim 13, wherein frequencies in the third band of frequencies are greater than frequencies in the first band of frequencies, and wherein frequencies in the first band of frequencies are greater than frequencies in the second band of frequencies.

16. The integrated wireless transceiver of claim 1, wherein the radio and the frequency converter use at least one common frequency reference.

17. The integrated wireless transceiver of claim 1, wherein the integrated wireless transceiver has a first mode of operation and a second mode of operation, in the first mode operation the wireless transceiver transmits and receives signals using one or more bands of frequencies that are different than one or more bands of frequencies associated with the wireless LAN communications protocol, and in the second mode of operation the wireless transceiver transmits and receives signals using the one or more bands of frequencies associated with the wireless LAN communications protocol.

18. The integrated wireless transceiver of claim 1, wherein the second band of frequencies corresponds to an unlicensed band of frequencies.

19. A method, comprising:
converting a signal from baseband to a first band of frequencies;
converting the signal to a transmit signal in accordance with a wireless LAN communications protocol;
frequency converting the transmit signal from the first band of frequencies to a second band of frequencies, wherein frequencies in the second band of frequencies are less than frequencies in the first band of frequencies, and wherein the second band of frequencies is different than one or more bands of frequencies associated with the wireless LAN communications protocol; and
coupling the transmit signal to an antenna,
wherein the converting from baseband, the converting to the transmit signal, the frequency converting and the coupling are performed in an integrated transceiver.

20. A method, comprising:
coupling a receive signal from an antenna to a frequency converter;
frequency converting the receive signal from a first band of frequencies to a second band of frequencies, wherein frequencies in the first band of frequencies are less than frequencies in the second band of frequencies, and wherein the first band of frequencies is different than one or more bands of frequencies associated with a wireless LAN communications protocol;
converting the receive signal to a signal in accordance with the wireless LAN communications protocol; and
converting the signal at the second band of frequencies to baseband,
wherein the coupling, the frequency converting, the converting to the signal and the converting to baseband are performed in an integrated transceiver.

21. An integrated wireless transceiver, comprising:
a first means for converting a first signal from a baseband to a first band of frequencies, converting the first signal into a first transmit signal in accordance with a wireless LAN communications protocol, converting a first receive signal into a second signal in accordance with the wireless LAN communications protocol and converting the second signal from the first band of frequencies to the baseband;
a second means coupled to the radio for converting the first transmit signal from the first band of frequencies to a second band of frequencies, and converting the first receive signal from the second band of frequencies to the first band of frequencies, wherein the second band of frequencies is different than one or more bands of frequencies associated with the wireless LAN communications protocol;
a third means coupled to the second means; and
at least one antenna coupled to the third means,
wherein in a first configuration the third means couples the first transmit signal from the second means to the antenna, and in a second switching configuration the third means couples the first receive signal from the antenna to the second means, and wherein the first means is configured to provide instructions to select a respective configuration of the third means.
